(19) United States
(12) Patent Application Publication
(10) Pub. No.: US 2006/0101169 A1
(43) Pub. Date: May 11, 2006

(54) Device and method for generating a logical path between connection of control device connected to a host device and memory device provided in said control device

(76) Inventors: Akio Shiga, Hadano (JP); Dai Taninaka, Odawara (JP); Tatsuya Murakami, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/020,548

(22) Filed: Dec. 27, 2004

(30) Foreign Application Priority Data
Nov. 5, 2004 (JP) 2004-322071

(51) Int. Cl. G06F 3/06

(52) U.S. Cl. 710/36

(57) ABSTRACT

A control device (4A) has a plurality of memory devices (1A), a first connection (92B) to be connected to a host device, and a second connection (92A) to be connected to an external memory control device (4B). The plurality of memory devices includes a memory device associated with the external memory device (4A). Provided are a first specifying unit (800) for specifying a host access external memory device, which is to be accessed by the host device, among the plurality of external memory devices; a second specifying unit (800) for specifying a mapping memory device, which is associated with the specified host access external memory device, among the plurality of memory devices; and a logical path generation unit for generating a logical path between the specified mapping memory device and the first connection.

### CROSS-REFERENCE TO PRIOR APPLICATION

This application relates to and claims priority from Japanese Patent Application. No. 2004-322071, filed on Nov. 5, 2004 the entire disclosure of which is incorporated herein by reference.

### BACKGROUND OF THE INVENTION

1. Field of the Invention

The present invention relates to a technology for generating a logical path between the connection of a control device to be connected to a host device, and the memory device provided in such control device.

2. Background of The Invention

For example, in a database system that handles enormous amounts of data such as in a data center, data is managed with a memory system constituted separately from the host computer. This memory system, for example, is constituted from the likes of a disk array device. A disk array device is constituted by disposing numerous memory devices in an array, and, for instance, is constituted based on RAID (Redundant Array of Independent Inexpensive Disks). At least one or more logical volumes (logical units) are formed on the physical memory area provided by the memory device group, and this logical volume is provided to the host computer (specifically, a database program operating on the host computer). The host computer is able to write and read data in relation to the logical volume by transmitting prescribed commands.

Pursuant to the advancement of information society, data to be managed in the database is increasing daily. Thus, a high-performance, large-capacity memory control device is being sought, and new models of memory control devices are being developed to meet the market needs. There are two ways to introduce a new memory control device in a memory system. One method is to completely replace the old memory control device with the new memory control device, and to constitute the memory system only from the new memory control devices (National Publication of Translated Version No. 10-508967). The other method is to newly add new memory control devices to the memory system constituted from old memory control devices, and to have the old and new memory control devices coexist.

### SUMMARY OF THE INVENTION

Meanwhile, it would be convenient if, in a memory system in which the host device is connected to the second memory control device (e.g., old memory control device), a first memory control device (e.g., new memory control device) is connected to the second memory control device, the host device is further connected to the first memory control device, and the host device is able to access the second memory control device via the first memory control device. This is because the second memory control device can be effectively used while using the first memory control device.

Nevertheless, in the foregoing case, it will be necessary to set a logical path between the connection of the first memory control device to be connected to the host device, and the memory device of the first memory control device. The lighter the burden upon setting this logical path, the better it is for the manager (e.g., user).

Accordingly, an object of the present invention is to reduce the burden required upon setting a logical path between the connection of the control device connected to the external memory control device, and the memory device provided in such a control unit.

Other objects of the present invention will become clear from the following explanation.

For example, an external memory control device and a host device are connected to a control device. The external memory control device has a plurality of external memory devices containing an external memory device to be accessed by the host device. Further, the control device has a plurality of memory devices, a first connection (e.g., a communication port) to be connected to the host device, and a second connection (e.g., a communication port) to be connected to the external memory control device. The plurality of memory devices include a memory device associated with an external memory device. Here, the device according to a first aspect of the present invention comprises: a first specifying unit for specifying a host access external memory device, which is an external memory device to be accessed by the host device, among the plurality of external memory devices; a second specifying unit for specifying a mapping memory device, which is a memory device associated with the specified host access external memory device, among the plurality of memory devices; and a logical path generation unit for generating a logical path between the specified mapping memory device and the first connection.

Here, as described above, since a “mapping memory device” is a memory device associated with the host access external memory device, it comprises a control device. The “mapping memory device being associated with the host access external memory device” means, for instance, that the identifying information for identifying the host access external memory device, and the identifying information for identifying the mapping memory device are associated in a prescribed area of the control device. Here, the control device, as a result of referring to its prescribed memory area, is able to specify which memory device among the plurality of memory devices is the memory device associated with the host access external memory device.

In the first embodiment of this device, the first specifying unit inputs host external information containing external device identifying information for identifying the host access external memory device, and acquires the external device identifying information from the host external information; the second specifying unit acquires identifying information of the mapping memory device associated with the acquired external device identifying information from the mapping information in which identifying information of the memory device is associated with the identifying information of the external memory device; and the logical path generation unit generates host first path information containing identifying information of the acquired mapping memory device, and connection identifying information of the first connection connected to the host device among one or more first connections.

In the second embodiment of this device, the connection identifying information in the first embodiment is a number for specifying a first connection. The logical path generation unit acquires an unused number if the number scheduled to be contained in the host first path information has already been assigned to another first connection in the control device, and generates host first path information containing the acquired unused number. In this second embodiment, for example, the device has a prescribed memory area, and this memory area (e.g., memory) has recorded thereon a number that cannot be assigned since it is being used, and a number that can be assigned since it is not being used. The device renews the contents recorded in the memory area when a given number is assigned to the first connection, or when the assignment of a given number is cancelled. In other words, by referring to the memory area, it is possible to specify which number is an unused number.

In the third embodiment of this device, the host external information in the first embodiment contains an external logical unit number associated with the host access external memory device. The logical path generation unit determines whether the external logical unit number acquired from the host external information is usable in the control device, and, if usable, includes the external logical unit number in host first path information as the logical unit number associated with the mapping memory device, and, if unusable, acquires a usable logical unit number, and generates host first path information containing the acquired logical unit number.

In the fourth embodiment of this device, the external memory control device in the first embodiment performs IO processing to the external memory device according to the IO request from the host device, generates IO monitor data, which is data relating to the IO processing, for each external memory device, and outputs IO-related information containing the identifying information of the external memory device and the IO monitor data. The host external information is the IO-related information. The first specifying unit receives the IO-related information output from the external memory control device, and acquires identifying information of the external memory device from the IO-related information.

In this fourth embodiment, for example, when the external memory control device is to register the number of the connection subject to the IO request and the identifying information of the external memory device in a prescribed memory area and output IO-related information, it will output IO-related information containing the number of the connection registered in the memory area and the external memory device identifying information contained therein. The logical path generation unit diverts the number of the connection contained in such IO-related information as the number of the first connection, and generates a logical path containing such number, and the identifying information of the mapping memory device. If such number is already being used in another device, the logical path generation unit may search for an unused number, and used the found unused number as a substitute.

In the fifth embodiment of this device, the host external information in the first embodiment is a text file described in a prescribed format. For example, when the external memory control device comprises a service processor, such service processor (hereinafter referred to as the external SVP) outputs host external information in a prescribed format. This host external information in a prescribed format may be input to the device via a communication network or a storage medium (e.g., flexible disk).

In the sixth embodiment of this device, the first specifying unit, the second specifying unit and the logical path setting unit are mounted on at least one of the control device, the host device and the external memory control device in a concentrated or dispersed manner.

For example, an external memory control device and a host device are connected to a control device. The external memory control device has a plurality of external memory devices containing an external memory device to be accessed by the host device. The control device has a plurality of memory devices, a first connection to be connected to the host device, and a second connection to be connected to the external memory control device. The plurality of memory devices include a memory device associated with an external memory device. This method comprises: a step of specifying a host access external memory device, which is an external memory device to be accessed by the host device, among the plurality of external memory devices; a step of specifying a mapping memory device, which is a memory device associated with the specified host access external memory device, among the plurality of memory devices; and a step of generating a logical path between the specified mapping memory device and the first connection.

For instance, an external memory control device and a host device are connected to a control device. The external memory control device has a plurality of external memory devices containing an external memory device to be accessed by the host device. The control device has a plurality of memory devices, a first port to be connected to the host device, and a second port to be connected to the external memory control device. The plurality of memory devices include a mapping memory device associated with an external memory device. This control device comprises: a memory area for storing one or more computer programs; and a processor operated by reading at least one among the one or more computer programs from the memory area.

This processor performs the processing steps (A) to (C) below:

(A) processing of inputting host external information containing external device identifying information for identifying the host access external memory device to be accessed by the host device, and acquiring the external device identifying information from the host external information;

(B) acquiring identifying information of the mapping memory device associated with the acquired external device identifying information from the mapping information in which the identifying information of the memory device is associated with the identifying information of the external memory device; and

(C) generating host first path information containing the acquired identifying information of the mapping memory device, and the number of the first connection connected to the host device among the one or more first connections.

Incidentally, the “control device” may be a personal computer, or may also be a memory device similar to the external memory control device. Incidentally, in the case of the latter, the control device does not necessarily have to comprise a memory device.

Further, the “processor” may be a microprocessor (e.g., microprocessor provided to the CHA or DKA described later), or a service processor.

### BRIEF DESCRIPTION OF THE DRAWINGS

FIG. 1 is a diagram showing the constitution of the memory system pertaining to the first embodiment of the present invention;

FIG. 2 is a diagram showing an outline of the scheme of the LDEV of the second memory control device being provided to the host device as the internal LDEV of the first memory control device;

FIG. 3 is a diagram showing an outline of the processing flow until a logical path is formed between the internal LDEV mapped to the external LDEV, and the port of the first memory control device connected to the host device;

FIG. 4 is a diagram for explaining the outline of the host first connection information generation processing to be performed in the first memory control device;

FIG. 5A is a diagram showing the configuration example of the host second connection information; FIG. 5B is a diagram showing the configuration example of the first and second connection information; FIG. 5C is a diagram showing the configuration example of the host first port information; FIG. 5D is a diagram showing the configuration example of the host first connection information; and FIG. 5E is a diagram showing the configuration example of the LDEV management information;

FIG. 6 is a diagram showing a part of the processing flow until the host first connection information is generated;

FIG. 7 is a diagram showing the remaining part of the processing flow until the host first connection information is generated;

FIG. 8A is a diagram showing the changes in the first embodiment and second embodiment regarding the flow of the host first connection information generation processing; and FIG. 8B is a diagram showing the other changes in the first embodiment and second embodiment regarding the flow of the host first connection information generation processing;

FIG. 9 is a diagram showing the changes in the first embodiment and third embodiment regarding the flow of the host first connection information generation processing;

FIG. 10 is a diagram showing the flow of the processing for creating the mapping table in the third embodiment, which is one embodiment of the present invention;

FIG. 11 is an explanatory diagram for explaining the concept of the memory system pertaining to an embodiment of the present invention; wherein FIG. 11A is a diagram showing the state of the logical path being set between the first memory control device connected to the second memory control device, and the host device; and FIG. 11B is a diagram showing the state after the logical path has been set between the first memory control device and the host device; and

FIG. 12 is a diagram showing the configuration example of the mapping table in the mainframe system.

### DETAILED DESCRIPTION OF THE PREFERRED EMBODIMENTS

An embodiment of the present invention is now explained with reference to the diagrams.

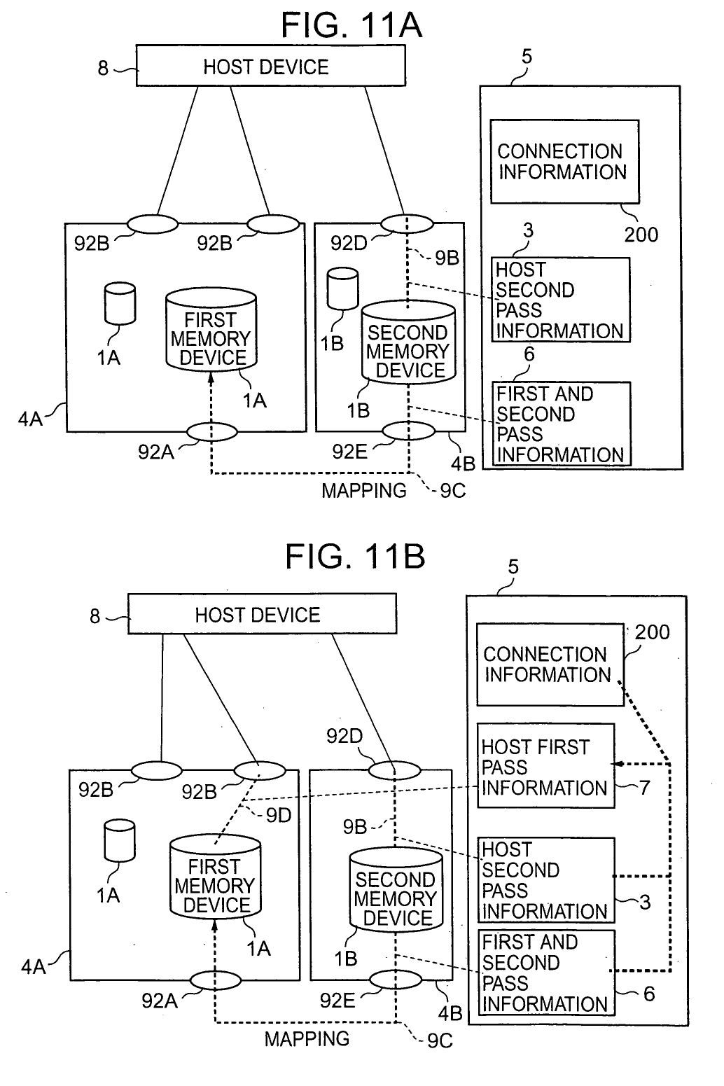

FIG. 11 is an explanatory diagram for explaining the concept of the memory system pertaining to an embodiment of the present invention; wherein FIG. 11A is a diagram showing the state of the logical path being set between the first memory control device connected to the second memory control device, and the host device; and FIG. 11B is a diagram showing the state after the logical path has been set between the first memory control device and the host device.

As shown in FIG. 11A, there is a second memory control device (e.g., old memory control device) 4B. The second memory control device 4B has connections 92D, 2E and a second memory device 1B. The second memory device 1B may be a physical memory device (e.g., hard disk), or a logical memory device set on 1 or a plurality of physical memory devices, or a directory or file stored in such a logical memory device.

The host device 8 is connected to the connection 92D of the second memory control device 4B. A logical path 9b is set between the connection 92D (or host device 8) and the second memory device 1B of the second memory control device 4B. As information representing this logical path 9B, there is host second path information 3. This host second path information 3, for example, is information containing the ID (e.g., WWN (World Wide Name)) of the connection 92D, and the ID (e.g., number or name) of the second memory device 1B. The host second path information 3 may be the host second connection information described later in the embodiments, or the IO-related information described later in another embodiment. This information 3 is stored in the memory area 5 (memory area provided to a memory or hard disk) prepared for the memory system according to the present embodiment. The memory area 5 may be provided to one among the host device 8, second memory control device 4B and first memory control device 4A, or may be distributed at least into two and disposed in the foregoing devices. The host device 8 (or second memory control device 4B) is able to access the second memory device 1B (or host device 8) according to the logical path 9B represented with the host second path information 3.

A connection 92A of a first memory control device (e.g., new memory control device) 4A is connected to another connection 92E of the second memory control device 4B. The first memory control device 4A, in addition to the connection 92A, comprises another connection 92B and a first memory device 1A. The first memory device 1A may be a physical memory device (e.g., hard disk), or a logical memory device set on 1 or a plurality of physical memory devices, or a directory or file stored in such a logical memory device, or may be an intangible virtual memory device unlike the physical or logical memory device described above.

A logical path 9C is set between the second memory control device 4B and the first memory control device 4A. As information representing this logical path 9C, there is the first second path information 6. The first second path information 6, for example, is information containing the ID of the first memory device 1A, ID of the connection 92A, ID of the connection 92E, and ID of the second memory device 1B. This information 6 is stored in the memory area 5. The first memory control device 4A is able to access the second memory device 1B according to the logical path 9C represented with the first second path information 6. Specifically, for example, when the first memory device 1A is a memory device, and the I/O request (data writing order or reading order) to such memory device is received from the host device 8, the first memory control device 4A issues an I/O request to the second memory device 1B mapped to the first memory device 1A based on the first second path information 6. Further, for instance, when the first memory device 1A is a tangible memory device (e.g., a logical memory device), and a writing command to such memory device is received from the host device 8, the first memory control device 4A writes data in the first memory device 1A, and issues the data writing order to the second memory device 1B mapped to the first memory device 1A based on the first second path information 6.

As described above, in the memory system, when the host device 8 is connected to another connection 92B, 2B of the first memory control device 4A, in order to enable the host device 8 to access the first memory device 1A, as shown in FIG. 11B, it is necessary to set a logical path 9D between at least one connection 92B, and the first memory device 1A mapped to the second memory device 1B. In other words, when the first memory device 1A is mapped to the second memory device 1B, in addition to setting a logical path 9B between the connection 92D (or host device 8) and the second memory device 1B, unless a logical path 9D is also set between the connection 92B (or host device 8) and the first memory device 1A, the host device 8 will not be able to recognize the first memory device 1A, nor will it be able to use the second memory control device 4B via the first memory control device 4A.

When this kind of setting of the logical path 9D is conducted manually, the burden on the manager who has to make such setting will become significant. This is even more prominent when either the second memory device 1B or first memory device 1A exists in a plurality, and the number of mappings of the second memory device 1B and first memory device 1A to be performed increases. Moreover, in the foregoing case, the possibility of an error occurring in the setting of the logical path will increase.

Thus, pursuant to the idea described below, the present embodiment is able to reduce the burden upon setting the logical path 9D.

In other words, connection information 200 is prepared in the memory area 5, for example. The connection information 200 represents at least to which connection 92B of the first memory control device 4A the host device is connected. For example, the connection information 200 is information representing the correspondence of the ID of the connection 92B and the ID (e.g., name, WWN or IP address) of the host device.

Based on this connection information 200, and the host second path information 3 and first second path information 6 described above, host first path information 7 representing the logical path 9D between the connection 92B (or host device 8) and the first memory device 1A is generated and set in the memory area 5.

Specifically, for example, the second memory device 1B that can be used by the host device 8 is specified from the host second path information 3. Further, the first memory device 1A mapped to the second memory device 1B is specified from the first second path information 6. Moreover, the connection 92B connected to the host device 8 is specified from the connection information 200. The ID of the specified connection 92B and the ID of the specified first memory device 1A are used to generate the host first path information 7 representing the logical path 9D between the connection 92B and first memory device 1A. This information 7, for example, is information containing the ID of the connection 92B and the ID of the first memory device 1A.

More specifically, for instance, in this embodiment, the ID of the first memory device 1A and the ID of the second memory device 1B are included in the first second path information 6, and the ID of the second memory device 1B and the ID of the connection 92D connected to the host device are included in the host second path information 3, and the ID of the connection 92B connected to the host device is included in the connection information 200. When it is detected that an ID that is the same as the ID of the second memory device is included in both the host second path information 3 and first second path information 6, the ID of the first memory device 1A corresponding to the second memory device to be accessed by the host device can be specified. Here, the host first path information 200 containing the ID of the specified first memory device 1A and the ID of the connection 92B specified with the connection information 200 is generated.

The processing for generating this host first path information 7 may be performed with one among the host device 8, first memory control device 4A and second memory control device 4B, or at least two of such devices may share such processing.

Several embodiments pertaining to the present invention are now explained with reference to the drawings.

### Embodiment 1

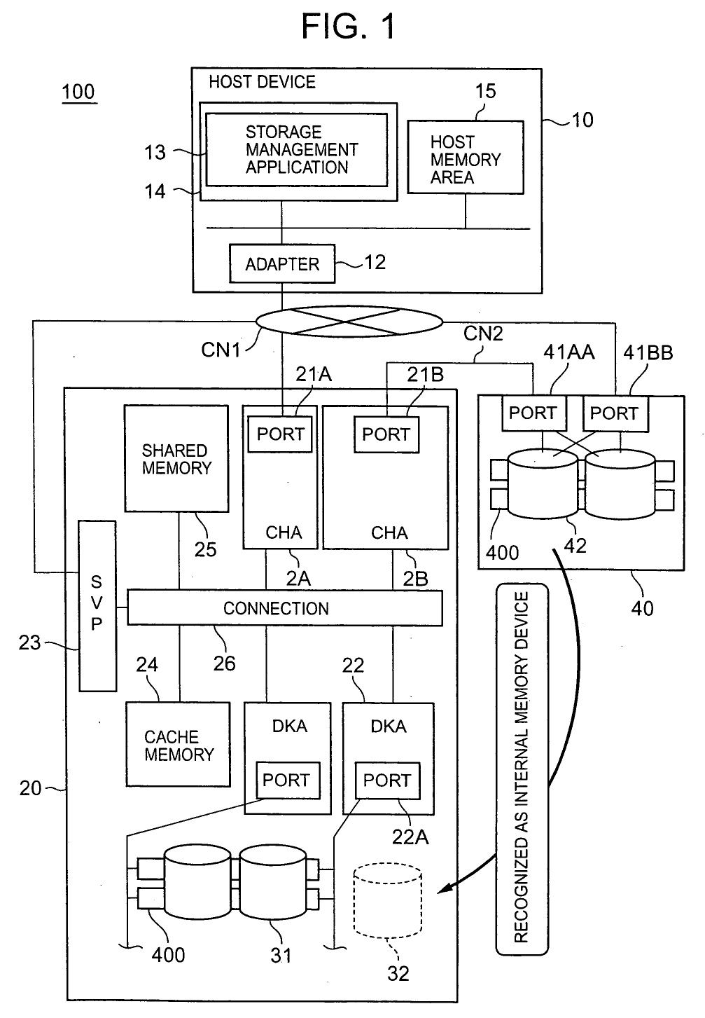

FIG. 1 is a diagram showing the constitution of the memory system pertaining to the first embodiment of the present invention.

This memory system 100 comprises a first memory control device 20 having one or more logical memory devices (herein after abbreviated as “LDEV”) 31, and second memory control device having one or more LDEV 42.

Connected to the first memory control device 20 are the host device 10 via the first communication network CN1, and the second memory control device 40 via the second communication network CN2. The host device 10 is connected to both the first memory control device 20 and second memory control device 40 via the first communication network CN1.

The host device 10 is a computer device comprising an information processing resource such as a processor (e.g., CPU (Central Processing Unit)) 14 or the host memory area (e.g., memory or hard disk) 15, and, for example, is constituted as a personal computer, workstation, or mainframe. The host device 10 comprises an information input device (not shown) such as a keyboard switch, pointing device, or microphone, and an information output device (not shown) such as a monitor display or speaker. Further, host device 10 is also provided with, for example, an application program (not shown) such as the database software which uses the memory area provided by the first memory control device 20, and an adapter 12 for accessing the first memory control device 20 via the first communication network CN1.

The host device 10 also comprises a storage management application 13. The storage management application 13 is stored, for example, in the host memory area 15. The storage management application 13, for instance, is a computer program to be loaded and operated with a processor 14, and is used for giving orders (control data) to the first memory control device 20, and controlling the operation of the first memory control device 20. Specifically, for example, the storage management application 13 is able to transmit various kinds of information to the first memory control device 20 (or second memory control device 40) via the SVP (Service Processor) 23 described later, or directly without passing through such SVP.

The host device 10 is able to input and output data to and from the first memory control device 20 (and second memory control device 40) via the first communication network CN1. As the communication network CN1, for instance, a LAN (Local Area Network), SAN (Storage Area Network), Internet, dedicated line, public line or the like as needed. Data communication via the LAN, for example, is conducted according to TCP/IP (Transmission Control Protocol/Internet Protocol). When the host device 10 is to be connected to the first memory control device 20 (and second memory control device 40) via the LAN, the host device 10 will designate a file name and request data I/O in file units. Meanwhile, when the host device 10 is to be connected to the first memory control device 20 (and second memory control device 40) via the SAN, the host device 10 will request data I/O in block units, which is a data management unit of the memory area provided by a plurality of disk memory devices, according to the fiber channel protocol. When the communication network CN1 is a LAN, the adapter 12, for example, is a LAN-compatible network card. When the communication network CN1 is a SAN, the adapter 12, for example, is host bus adapter.

The first memory control device 20 is constituted, for example, as a disk array subsystem. However, without being limited thereto, the first memory control device 20 can also be constituted to be a highly sophisticated, intelligent-type fiber channel switch. This also applies to the second memory control device 40.

The first memory control device 20 comprises a controller unit and one or a plurality of physical memory devices 400. The controller unit, for example, comprises a plurality (two for example) of channel adapters (CHA) 2A, 2B; a plurality of disk adapters (DKA) 22; a service processor (SVP) 23; a cache memory 24; a shared memory 25; and a connection 926.

CHA 2A, 2B are used for engaging in data transmission with an external device (e.g., host device 10 or second memory control device 40) connected to the first memory control device 20. Each CHA 2A, 2B comprises a communication port 21A, 21B for communicating with external devices. In this embodiment, CHA 2A is connected to the host device 10 via the communication port 21A and first communication network CN1, and CHA 2B is connected to the second memory control device 40 via the communication port 21B and second communication network CN2. CHA 2A, 2B are respectively constituted as a microcomputer system comprising an MP (Micro Processor) (not shown), memory and so on, and interprets and executes the various commands received from external devices. For example, a network address (e.g., IP address or WWN) is assigned to the CHA 2A, 2B for identification, and in such a case, each CHA 2A, 2B will independently act as a NAS (Network Attached Storage).

Each DKA 22 is for transferring data with the physical memory device 400. Each DKA 22 comprises a communication port 22A for connecting with the physical memory device 400. Moreover, each DKA 22 is constituted as a microcomputer system comprising a CPU, memory and the like. Each DKA 22, according to the instructions from CHA 2A, 2B, writes data in the physical memory device 400, and reads data from the physical memory device 400. When conducting data I/O with the physical memory device 400, each DKA 22 converts the logical address into a physical address. Each DKA 22 conducts data access according to the RAID constitution when the physical memory device 400 is managed according to RAID.

The SVP 23 is a computer device to be operated for the maintenance or management of the first memory control device 20, for example, is a laptop personal computer. The SVP 23 is able to monitor the malfunctions in the device 20 and display this on the display screen (not shown), or give instructions such as the locking processing of a physical memory device (e.g., hard disk drive) comprising the LDEV 31 based on the command from the storage management application 13.

The cache memory 24 is used for temporarily storing data received from the host device 10 or data read out from the LDEV 31. Stored in the shared memory 25 is control information for controlling the operation of the first memory control device 20, and information for expressing the correspondence of each LDEV 31 and each physical memory device 400. Incidentally, the LDEV 31 may be used as a cache disk.

The connection 926 mutually connects each CHA 21, each DKA 22, SVP 23, cache memory 24, and shared memory 25. The connection 926, for example, may be constituted to be a high-speed bus such as an ultra fast crossbar switch for performing data transmission with high-speed switching. Further, it may also be constituted as a communication network such as a LAN or SAN, and may be constituted from a plurality of networks together with the foregoing high-speed bus.

As the physical memory device 400, for example, devices such as a hard disk, flexible disk, magnetic tape, semiconductor memory, optical device and the like can be used. One or more LDEV 31 are provided on the one or a plurality of physical memory devices 400. Incidentally, in order to simplify the following explanation, there may be cases where the LDEV 31 provided to the first memory control device 20 is referred to as the “internal LDEV 31”, and the LDEV 42 provided to the second memory control device 40 is referred to as the “external LDEV 42”.

Reference numeral 32 shown with the dotted line in FIG. 1 is a virtual internal LDEV to be provided to the host device 10. To put it a different way, reference numeral 32 shows the external LDEV 42 provided in the second memory control device 40 being virtually incorporated to the side of the first memory control device 20. In other words, in the present embodiment, the LDEV 42 existing outside when viewed from the first memory control device 20 is provided to the host device 10 as the LDEV 32 provided inside the first memory control device 20. To put it differently, since the first memory control device 20 is able to provide the LDEV 42 provided in the second memory control device 40 as one's own LDEV 32 to the host device 10, it does not have to be provided with a local LDEV 31 (i.e., the physical memory device 400 for providing such LDEV 31) that it will directly control. That is, even if the first memory control device 20 is not provided with the LDEV 31 at all, it is still possible to provide the memory resource to the host device 10.

The second memory control device 40 may adopt the same constitution as the first memory control device 20. For example, the second memory control device 40 comprises a communication port 41AA to be connected to the host device 10, a communication port 41BB to be connected to the first memory control device 20, and the LDEV 42. In addition, CHA, DKA and so on may be provided. The second memory control device 40 is connected to the first memory control device 20 via the second communication network CN2, and the external LDEV 42 is handled as the internal LDEV 32 of the first memory control device 20.

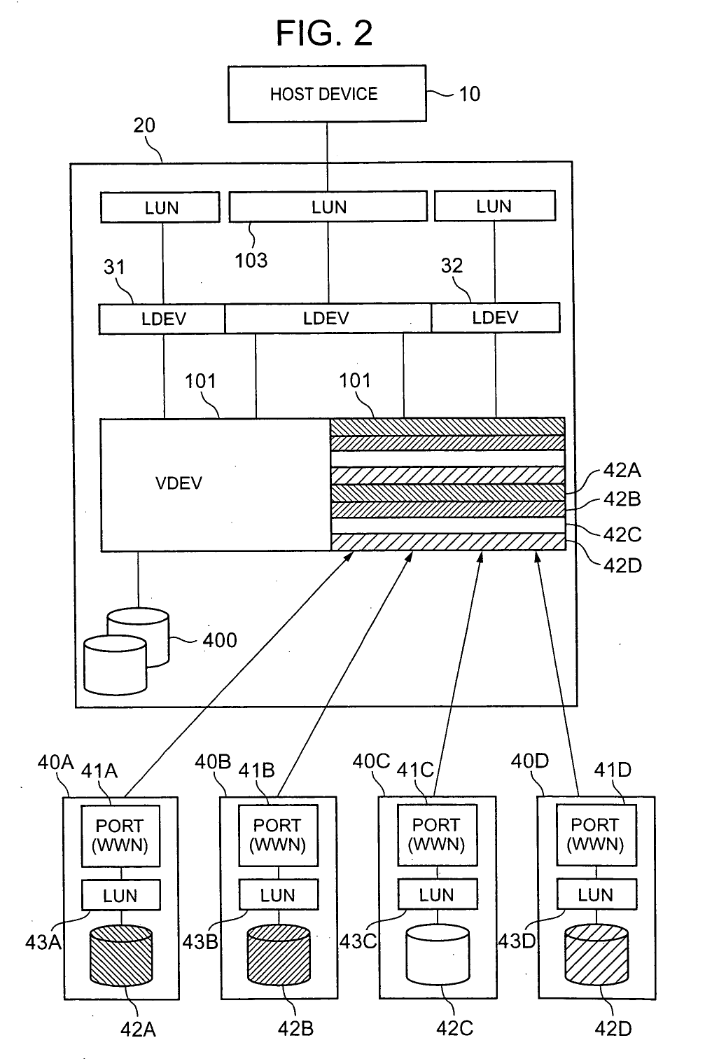

FIG. 2 is a diagram showing an outline of the scheme of the LDEV 42 of the second memory control device 40 being provided to the host device 10 as the internal LDEV of the first memory control device 20.

The first memory control device 20 has a triple memory layer formed from VDEV 101, LDEV 31, 32, and LUN 103 in order from the lower layer.

The VDEV 101 is a virtual device positioned at the lowermost logical memory layer. VDEV 101 is a virtualization of the physical memory resource, and the RAID constitution can be employed. In other words, a plurality of VDEV 101 can be formed (sliced) from a single physical memory device 400, or a single VDEV 101 can be formed (striping) from a plurality of physical memory device 400. The VDEV 101 shown in the left side of FIG. 2, for example, is a virtualization of the physical memory device 400 according a prescribed RAID constitution.

Meanwhile, the VDEV 101 shown on the right side of FIG. 2, is constituted by mapping the LDEV 42 of the second memory control device 40 (i.e., the physical memory device 400 for providing the LDEV 42). In other words, in the present embodiment, the LDEV 42 to be provided by the physical memory device 400 of the second memory control device 40 can be mapped to the VDEV 101, and be used as the internal LDEV 32 of the first memory control device 20. In the exemplified example, four second memory control devices 40A to 40D are provided, and, provided to these second memory control devices 40A to 40D are communication ports 41A to 41D to which WWN (World Wide Name), which is a unique identifying information, is assigned respectively, LUN (Logical Unit Number) 43A to 43D, and LDEV 42A to 42D. Each LDEV 42A to 42D can be specified with the combination of WWN and LUN (e.g., also with the ID of the second memory control device).

LDEV 31, 32 are provided on the VDEV 101. A single VDEV 101 can be connected to a plurality of LDEV 31 (and/or 32), or a plurality of VDEV 101 can be connected to a single LDEV 31 (or 32). The host device 10 is able to access the LDEV 31 and/or 32 via a prescribed or desired LUN 103.

As described above, in the present embodiment, as a result of connecting an external LDEV 42 to the middle memory layer (VDEV 101, LDEV 32) positioned between the LUN 103 and external LDEV 42, the external LDEV 42 can be used as one of the internal LDEV 32 inside the first memory control device 20. Specifically, for example, when the first memory control device 20 receives an I/O request (data writing or data reading command) directed from the host device 10 to the internal LDEV 32 from CHA 2A, the external LDEV 42 associated with the internal LDEV 32 via the VDEV 101 pursuant to CHA 2B can be accessed.

The foregoing is the outline of the memory system 100 according to the present invention. Incidentally, in this memory system 100, the LDEV mapped to the external LDEV 42 does not necessarily have to a virtual LDEV 32, and for instance, may be a mounted LDEV 31. Here, the first memory control device 20, for instance, when receiving the writing order against such mounted LDEV 31 is received from the host device 10, the target data to be written can be written in the mounted LDEV 31, and such data can also be written in the external LDEV 42 mapped with the mounted LDEV 31. Further, the cache memory 24 and shared memory 25 do not necessarily have to be physically apart, and, for instance, a method of preparing an area to be used as the cache memory and an area to be used as the shared memory on the same memory can be adopted.

Meanwhile, in the present embodiment, for instance, when the first memory control device 20 is connected to the second memory control device 40 connected to the host device 10, the first memory control device 20 can semi-automatically (i.e., via operations requiring much fewer manual operations in comparison to a case of doing everything manually) form a logical path between the host device 10 and the internal LDEV 32 associated with the external LDEV 42.

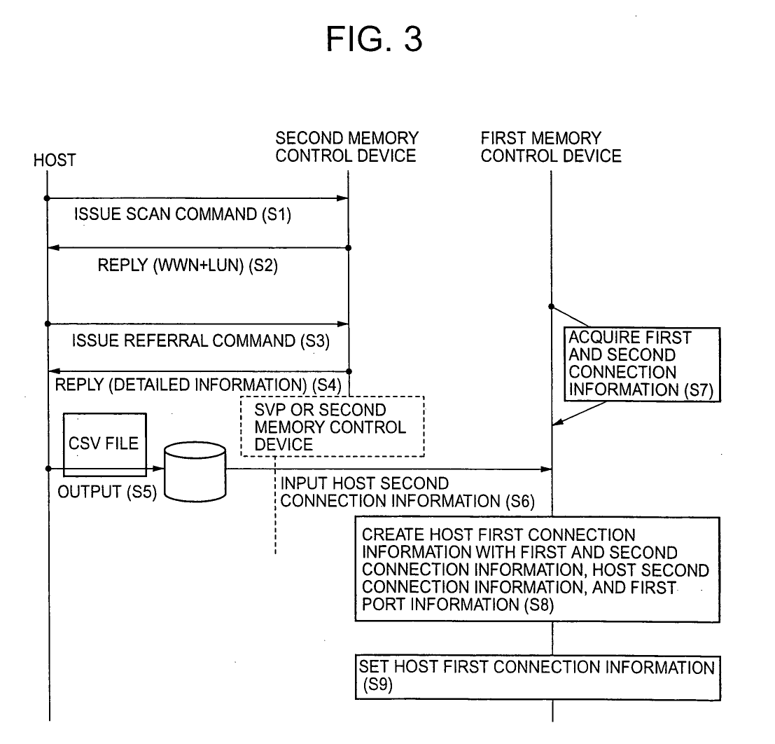

FIG. 3 is a diagram showing an outline of the processing flow until a logical path is formed between the internal LDEV mapped to the external LDEV, and the port of the first memory control device connected to the host device. Incidentally, in the following explanation, the port of the second memory control device connected to the host device 10 is referred to as the “host second port”, the WWN of such port is referred to as the “host second WWN”, the LUN in the second memory control device 40 is referred to as the “host second LUN”, and the LDEV (i.e., LDEV existing in the second memory control device 40) belong to the host second LUN is referred to as the “external LDEV”. Moreover, in the following explanation, the port of the first memory control device connected to the host device 10 is referred to as the “host first port”, the WWN of such port is referred to as the “host first WWN”, the LUN in the first memory control device 20 is referred to as the “host first LUN”, and the LDEV (i.e., LDEV existing in the first memory control device 20) belong to the host first LUN is referred to as the “internal LDEV”. Further, in the following explanation, the port of the second memory control device 40 connected to the first memory control device 20 is referred to as the “first second port”, and the port of the first memory control device 20 connected to the second memory control device 40 is referred to as the “second first port”.

The host device 10 (e.g., storage management application 13) transmits a prescribed command (e.g., scanning command according the a SCSI protocol) to the second memory control device 40 (step S1).

When the second memory control device 40 receives the prescribed command, responds to the host device 10 with the data relating to the host second port 41BB which received the command (e.g., the host second WWN of such port and the host second LUN (Logical Unit Number) belonging to such port) (S2). Incidentally, data concerning this port, for example, is extracted from the LDEV management information (e.g., information registering the correspondence of the WWN of each port and the host second LUN and the external LDEV number) stored in the memory area (e.g., shared memory) of the second memory control device, and then transmitted.

After the host device 10 receives data relating to the port from the second memory control device 20, it uses such data and transmits a prescribed referral command to the second memory control device 40 (S3). Specifically, for example, the host device 10 transmits the WWN received at S2 ad the inquiry command (command according to a SCSI protocol) designating the host second LUN.

When the second memory control device 40 receives this referral command, it replies to the host device with the detailed information containing a plurality of information elements as the response (S4). Detailed information, for example, includes the vendor code of the second memory control device 40, number of the second memory control device 40, number of the external LDEV belong to the designated host second LUN, and the memory capacity of such external LDEV. Detailed information, for example, can be constituted with prescribed types of information elements selectable from the LDEV management information stored in the second memory control device 40.

When the host device 10 receives such detailed information, it generates host second connection information relating to the connection with the host device 10 and second memory control device 40 by using such detailed information and the data received at S2. This host second connection information, for example, is a data file (e.g., CSV (Comma-Separated Value) file) constituted in a prescribed format. The host device 10 outputs the host second connection information to the host memory area 15 (S5).

Further, the host device 10 reads out the host second connection information, and inputs such read out host second connection information to the first memory control device 20 (S6). The host second connection information is able to make input via the SVP 23 or second memory control device 40, or directly without going through the SVP 23 or second memory control device 40.

The first memory control device 20 (e.g., CHA 2A) acquires the first second connection information, which is information relating to the connection of the second memory control device 40 and first memory control device 20 (S7).

Further, the first memory control device 20 (e.g., CHA 2A that received the host second connection information) creates host first connection information representing the logical path between the host first port 21A and the internal LDEV by using the acquired first second connection information, the input host second connection information, and the host first port information, which is information relating to the host first port (S7). And, the first memory control device 20 sets the host first connection information by storing the host first connection information that it created in a prescribed memory area (S8).

The processing exemplified in FIG. 3 is now explained in detail.

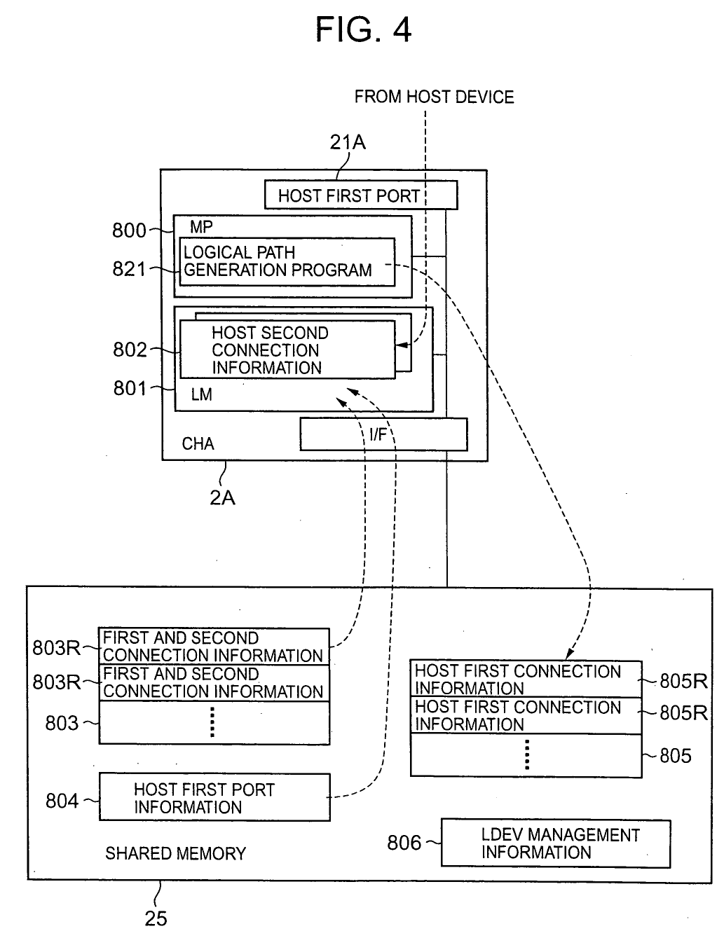

FIG. 4 is a diagram for explaining the outline of the host first connection information generation processing to be performed in the first memory control device 20.

The first memory control device 20, as described above, comprises CHA 2A to be connected to the host device 10 and a shared memory 25. CHA 2A comprises a host first port 21A, a microprocessor (hereinafter MP) 800, and a local memory (hereinafter LM) 801.

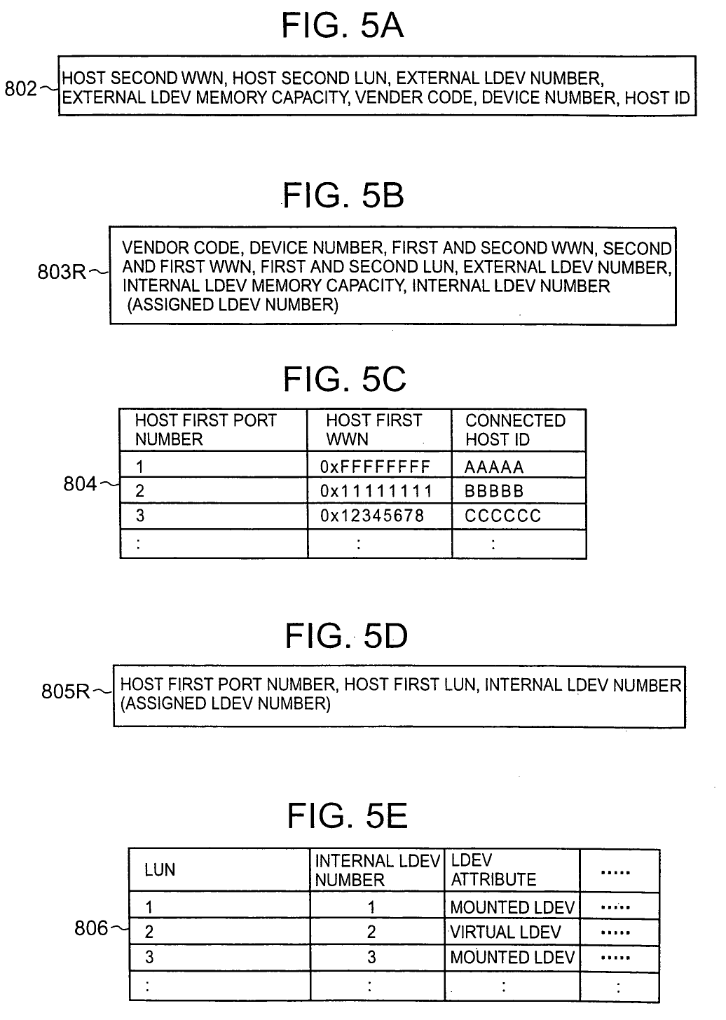

The input host second connection information 802 is stored in the LM 801. The host second connection information 802, for example, as shown in FIG. 5A, includes a host second WWN (i.e., WWN of host second port), host second LUN, external LDEV number, external LDEV memory capacity, vendor code of second memory control device 40, device number of such device 40, and the host ID (e.g., WWN) of the host device connected to the port having such host second WWN. The host ID, for example, is included in the host second connection information 802 by the host device 10.

MP 800 is capable of generating host first connection information 805R by reading, for example, a prescribed computer program (hereinafter referred to as the “logical path generation program”) 821 from the LM 801.

The logical path generation program 821 reads the first second connection information 803R from the mapping table 803 representing information concerning the association of external LDEV and internal LDEV. The mapping table 803 is constituted from a plurality of first second connection information (e.g.; records) 803R, and, for example, is registered in the shared memory 25. The first second connection information 803R, for example, as shown in FIG. 5B, is information containing the vendor code of the second memory control device 40, device number of such device 40, WWN of the first second port, WWN of the second first port, first second LUN, external LDEV number, memory capacity of the internal LDEV associated with the external LDEV (hereinafter sometimes referred to as the “assigned LDEVL”), and the number of such internal LDEV.

When the logical path generation program 821 detects that the same external LDEV number is contained in both the host second connection information 802 stored in the LM 801, and the read first second connection information 803R, by referring to the host first port information 804, it is able to specify the host first port 21 connected to the host device specified from the host ID in the host second connection information 802 among the plurality of ports 21A, 21B. The host first port information 804, for example, is information stored in the shared memory 25. The host first port information 804 may be stored in the shared memory 25 in advance, or input from the SVP 23 in a prescribed timing. The host first port information 804, for example, as shown in FIG. 5C, has registered therein the number and WWN of the host first port, and the ID of the host device 10 connected to such port for each host first port. The correspondence between the WWN and port number, for example, is one-on-one; that is, they are of a relationship where the same port number will not be assigned to a plurality of WWN.

The logical path generation program 821 distinguishes the number of the specified host first port 21A from the host first port information 804, and, as illustrated in FIG. 5D, generates host first connection information 805R containing the distinguished number, host first LUN, and internal LDEV number, and registers this in a prescribed memory area such as the shared memory 25. As a result, a logical path having a host first LUN is formed between the host first port 21A connected to the host device 10 and the internal LDEV 32 associated with the external LDEV 42.

Incidentally, the shared memory 25 has registered therein, for example, control information containing the port number and LUN that are unused since they have not yet been assigned, and the port number and LUN that are unusable since they have already been assigned. This control information is renewed when the number assigned to the likes of the host first port 21A is deleted or changed, or when the constitution of the logical path in the first memory control device 20 is changed.

Specifically, for example, the shared memory 25 contains a table 805 including one or more host first connection information 805R. The host first LUN contained in the host first connection information 805R, for example, is the same as the host second LUN contained in the host second connection information 803R (i.e., a case of the host second LUN being diverted as the host first LUN), and, if a LUN as the same such LUN is being used in the first memory control device 20, another LUN (e.g., unused number selected among a number in a prescribed range) is set as the host first LUN. Whether a LUN that is the same as the host second LUN is being used in the first memory control device 20 can be determined by the logical path generation program 821 referring to the LDEV management information 806 (e.g. registered in the shared memory 25) for managing the internal LDEV. In other words, when at least one internal LDEV in which a LUN that is the same as the host second LUN is associated with the LDEV management information 806, such LUN is judged as being used, and, when there is no such association, it is judged as not being used. LDEV management information 806 has registered therein, for example, as shown in FIG. 5E, for each LUN, the number of the internal LDEV belonging to such LUN, and the attribute of such internal LDEV (e.g., whether it is a virtual LDEV or mounted LDEV).

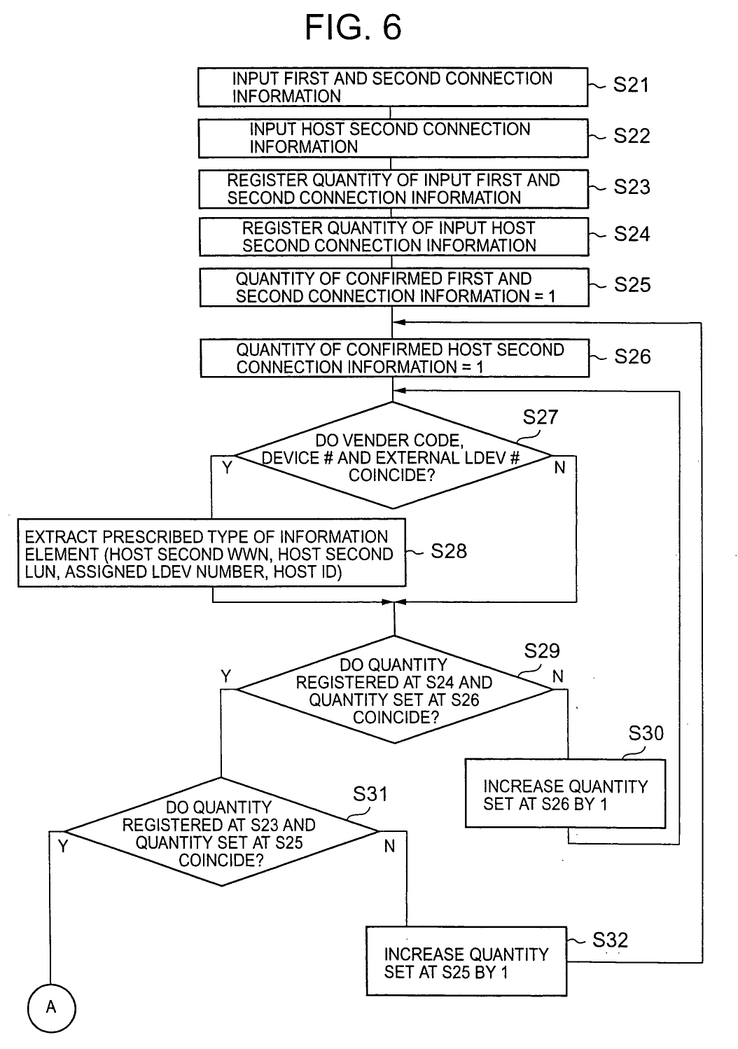

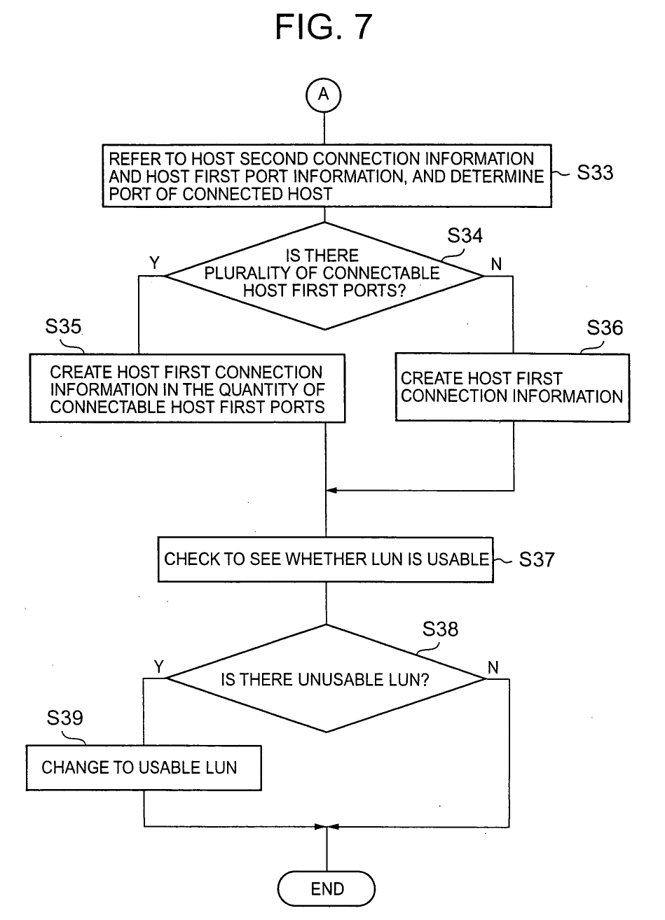

The processing flow until the host first connection information 805R is generated is now explained in detail with reference to FIG. 6 and FIG. 7.

The MP 800 that read the logical path generation program 821 respectively inputs the one or more first second connection information 803R contained in the mapping table 803 (S21). Further, the MP 800 respectively inputs the one or more first second connection information 803R existing in the LM 801 (S22). The MP 800 registers quantity of the input first second connection information 803R in the LM 801 (S23), and also registers the quantity of the input host second connection information 802 in the LM 801 (S24). Moreover, the MP 800 sets “1” as the quantity of the confirmed first second connection information (i.e., the referred first second connection information) in the LM 801, and also sets “1” as the confirmed host second connection information in the LM 801 (S26).

The MP 800 selects a given host second connection information 802 from the one or more host second connection information 802 which were input, and searches for the first second connection information 803R containing the vendor code included in the selected host second connection information 802, device number, and external LDEV number (S27).

When the MP 800 scores a hit in the search (YES at S27), it extracts prescribed types of information elements (e.g., host second port WWN, host second LUN, assigned LDEV number and host ID) from the host second connection information 803 or discovered first second connection information 803R (S28). Meanwhile, when the MP 800 could not score a hit (NO at S27), it performs the processing at S29.

The MP 800 determines whether the quantity registered at S24 and the quantity set at S26 coincide (S29), and, when it is judged as not coinciding (NO at S29), the quantity set at S26 is increased by 1 (S30), and the processing at S27 is performed. Meanwhile, when it is judged as coinciding (YES at S29), the processing at S31 is performed.

The MP 800 determines whether the quantity registered at S23 and the quantity set at S25 coincide (S31), and, when it is judged as not coinciding (NO at S31), the quantity set at S25 is increased by 1 (S32), and the processing at S26 is performed. Meanwhile, when it is judged as coinciding (YES at S31), the processing at S33 shown in FIG. 7 is performed.

The MP 800, at S33, determines the host first port associated with the host ID contained in the host second connection information 802 judged as coinciding at S27 from the host first port information 804 (S33).

The MP 800, when the quantity of the determined host first port 21A is 1 (NO at S34), generates host first connection information 805R containing the number of such port 21A, and the host second LUN and assigned LDEV number extracted at S28 (S36). Meanwhile, when the quantity of the determined host first port 21A is several (YES at S34), the MP 800 generates host first connection information 805R in the quantity of the determined ports 21A (S35). In the generated plurality of host first connection information 805R, the number of port 21A is different.

The MP 800 checks to see whether the host second LUN contained in the generated host first connection information 805R is being used in the first memory control device 20 (S37), and, when it is being used (YES at S38), such host second LUN is changed to a usable LUN (S39). Meanwhile, if it is not being used (NO at S38), the MP 800 ends the processing. Here, the host second LUN, as the host first LUN, forms the logical path between the host first port 21A and the internal LDEV 32.

According to the first embodiment described above, the host first connection information 805R representing the logical path between the host first port and the internal LDEV associated with the external LDEV is automatically generated based on the information acquired by issuing a command to the second memory control device 40, the first second connection information representing the association of the external LDEV and internal LDEV, and information concerning the host first port, and set in the first memory control device 20. As a result, when constituting a system where the first memory control device 20 is connected to the second memory control device 40, the host device 10 is connected to the first memory control device 20, and the first memory control device 20 provides to the host device 10 the memory resource of the second memory control device 40, the burden of setting a logical path between the host first port of the first memory control device 20 and the internal LDEV 32 mapped to the external LDEV 42 can be alleviated. Incidentally, information concerning the set logical path, for example, can be notified by the CHA 2A connected to the host device 10 receiving a prescribed command such as an inquiry command from the host device 10, and replying to such inquiry. As a result, the host device 10 is able to recognize how to access the internal LDEV 32 according to which logical path via the host first port to which it is connected.

Further, according to the first embodiment, as a result of performing the processing of S34 and S35 shown in FIG. 7, when a plurality of paths (replacement paths) is set against the same external LDEV 42, logical paths in the same quantity as such paths can be set in the first memory control device 20.

Incidentally, in this first embodiment, when the logical path between the host first port, and the internal LDEV 32 mapped to the external LDEV 42 is set in the first memory control device 20, the first memory control device 20 transmits a prescribed signal (e.g., signal indicating that the setting of the logical path is complete, or a signal signifying the order of cutting the logical path between the host device 10 and the external LDEV 42 mapped to the internal LDEV 32) to the second memory control device 40, and the second memory control device 40 may respond to this signal and cut the logical path between the host device 10 and the external LDEV 42 mapped to the internal LDEV 32 (e.g., information representing such logical path may be deleted).

Moreover, in the first embodiment, the host device 10 may also process the host second connection information 802 into a prescribed format (e.g., a predetermined format showing what kind of information elements are to be set between certain bites), and to output the host second connection information 802 processed into such prescribed format.

Moreover, in the first embodiment, the host device 10 may also extract only the types of information elements to be incorporated into the host first connection information 805R among the plurality of information elements contained in the host second connection information 802, generate information containing such extracted two or more information elements in a prescribed format, and output the generated information in such prescribed format.

### Embodiment 2

The second embodiment of the present invention is now explained. Incidentally, in the following explanation, differences with the first embodiment will be primarily explained, and the explanation regarding matters common to the first embodiment will be omitted, or simplified.

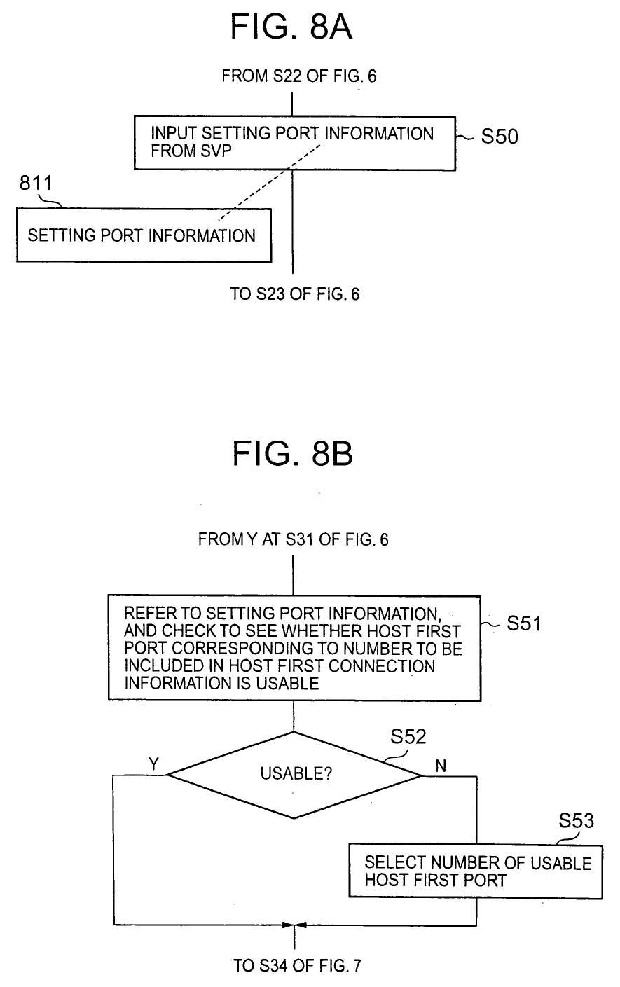

FIG. 8A is a diagram showing the changes in the first embodiment and second embodiment regarding the flow of the host first connection information generation processing.

Setting port information 811 is input to the CHA 2A in a prescribed timing (e.g., after S22 of FIG. 6) from the SVP 23 via the mounted LAN port not (S50). The setting port information 811 is information representing the usable host first port among the plurality of host first ports, and, for example, includes the number or WWN of the usable host first port. The input setting port information 811, for example, is stored in the LM 801.

Thereafter, processing of S23 onward of FIG. 6 is performed.

FIG. 8B is a diagram showing the other changes in the first embodiment and second embodiment regarding the flow of the host first connection information generation processing.

The MP 800 refers to the input setting port information 811 in a prescribed timing (e.g., after Y at S31 of FIG. 6), and checks to see whether the host first port corresponding to the number to be included in the host first connection information is usable (S51). As a result, when it is judged that such host first port cannot be used because it has already been associated with another host first LUN or other reasons (NO at S52), the MP 800 selects a usable host first port number by referring to at least the setting port information 811 and host first port information 804 (S53), and performs the processing of S34 shown in FIG. 7. Thereby, the selected host first port number will be a target to be included in the host first connection information 805R.

Incidentally, in this second embodiment, although the host first port information 804 and setting port information 811 exist separately, as a modified example thereof, contents of the setting port information 811 may be included in the host first port information 804. Specifically, for example, host first port information 804 containing the contents of the setting port information 811 may be input form the SVP 23.

In this second embodiment also, as with the first embodiment, the burden of setting a logical path between the host first port, and the internal LDEV associated with the external LDEV can be alleviated.

Incidentally, in this second embodiment, the SVP 23 may execute the host first connection information generation processing. In other words, the SVP 23 may receive the input of host second connection information 802 (e.g. text file written in CSV) from the host device 10. Further, the SVP 23 may also store the host first port information 804 or mapping table 803. The SVP 23 may also generate the host first connection information 805R based such stored information. Here, the SVP could judge whether the host first port number to be included in the information 805R is being used to determine if there would be a problem in setting the information 805R in the first memory control device 20, and, if there is a problem, it could change the problematic information element (e.g., host first port number) in the information 805R and thereafter make the setting.

Further, in this second embodiment, the second memory control device may also comprise an SVP (hereinafter referred to as the external SVP) storing the control information representing the constitution in the second memory control device. The external SVP has a memory area, and stores the host second connection information 802 on memory area thereof, and is able to output the host second connection information 802 in a prescribed format. The host second connection information 802 in a prescribed format may be input into the SVP 23 of the first memory control device 20 via a communication network or recording medium (e.g., flexible disk). Since the input host second connection information 802 is in a prescribed format, the SVP 23 is able to specify what kind of information element exists in the host second connection information 802. The SVP 23 may also generate the host first connection information 805R representing the logical path based on the specified contents, or may convert this into host second connection information 802 of a different prescribed format, and register the converted host second connection information 802 (or the host second connection information 802 input externally without change) in the shared memory 25 (or LM 801 of CHA 2A).

### Third Embodiment

The third embodiment of the present invention is now explained.

In this third embodiment, instead of acquiring the host second connection information, the IO-related information regarding the mapped external LDEV 42 is acquired from the second memory control device 20, and the information elements contained in the IO-related information are used to generate the host first connection information 805R. In this third embodiment, the second memory control device 40 generates IO monitor data representing the processing speed of IO requests (e.g., number of requests/second) for each external LDEV 42, and accumulates such IO monitor data in the likes of a shared memory. IO monitor data, for example, is output to the SVP of the second memory control device 40, and the SVP manager is able to peruse such IO monitor data. Further, the second memory control device 40 manages, in the shared memory, information concerning the logical path in the second memory control device 40, for example, the port number of the host second port 41 receiving the IO request, WWN of such port 41, LUN that received the IO request (i.e., corresponding to the port number), and number of the external LDEV accessed in response to such IO request.

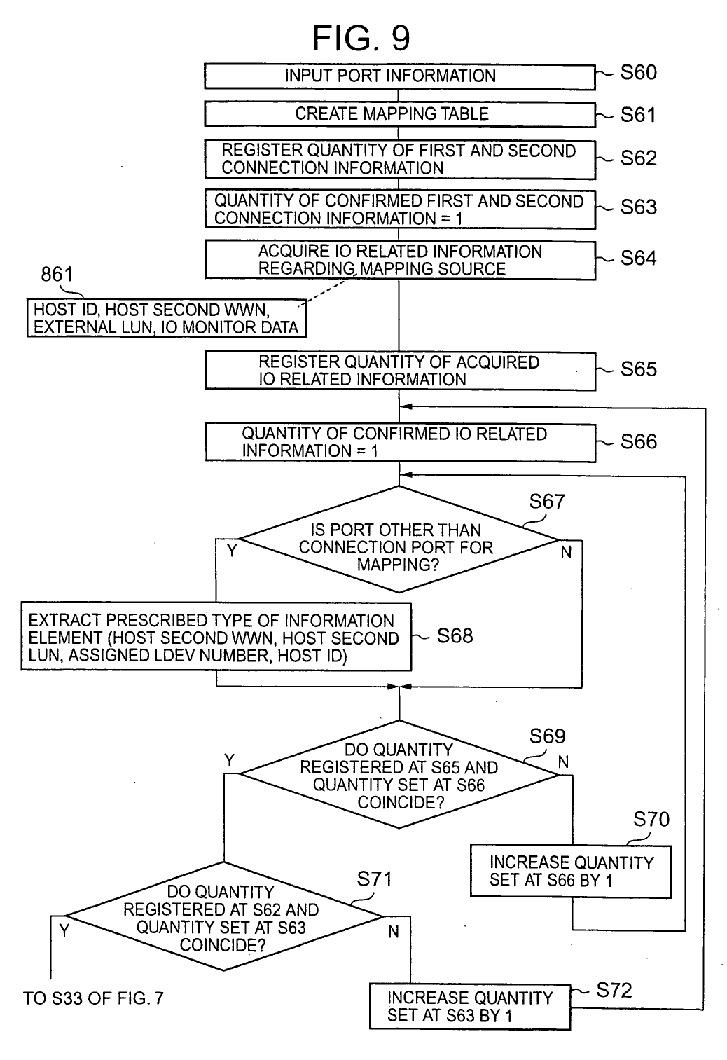

FIG. 9 is a diagram showing the changes in the first embodiment and third embodiment regarding the flow of the host first connection information generation processing.

For example, port information is input to the CHA 2a connected to the second memory control device 40 (S60). This port information contains information elements (e.g., number or WWN) relating to the second first port 21B.

CHA 2B (e.g., MP mounted thereon) specifies which second first port 21B should be used from the input port information, and, by issuing a prescribed command via the specified second first port 21B and second communication network CN2, a mapping table 803 having one or more first second connection information 803R can be created (S61).

CHA 2B registers the quantity of first second connection information 803R contained in the created mapping table 803 (S62), and sets “1” as the quantity of the confirmed first second connection information (S63).

The CHA 2B transmits a command for acquiring IO-related information to the second memory control device 40, and receives IO-related information 861 as the response to such command (S64). The address of the command can be represented, for example, from the number of the external LDEV specified with the mapping table 803, and the first second LUN associated thereto. The second memory control device 40 (e.g., CHA in such device 40), in response to such command, transmits to the CHA 2A the port number or WWN of the host second port that received the IO request, host second LUN or IO-related information containing IO monitor data as the information relating to the command address. IO monitor data, for example, represents the processing speed of the IO request (number of IO requests/second).

The CHA 2B, for example, is able to acquire IO-related information 861 in the same quantity as the external LDEV mapped to the internal LDEV. The CHA 2B registers the acquired quantity of IO-related information (S65), and sets “1” as the confirmed IO-related information in the LM 801 (S66).

The CHA 2B selects given IO-related information 861 among the one or more IO-related information 861, and determines whether the port number contained in the selected IO-related information is other than the connection port for mapping (i.e., port number of CHA 2B) (S67). The CHA 2B, if it is other than such port (i.e., if the port number contained in the IO-related information is the number corresponding to the host first port) (YES at S67), it specifies the first second connection information 803R containing the external LDEV number among the selected IO-related information 861, and extracts prescribed types of information elements from at least the IO-related information 861 and the specified first second connection information 803R (S68). The information elements extracted here, for example, are the host second WWN, host second LUN, assigned LDEV number and host ID.

The CHA 2B determines whether the quantity registered at S65 and the quantity set at S66 coincide (S69), and, when it is judged as not coinciding (NO at S69), the quantity set at S66 is increased by 1 (S70), and the processing at S67 is performed. Meanwhile, when it is judged as coinciding (YES at S69), the processing at S71 is performed.

The CHA 2B determines whether the quantity registered at S62 and the quantity set at S63 coincide (S71), and, when it is judged as not coinciding (NO at S71), the quantity set at S66 is increased by 1 (S72), and the processing at S66 is performed. Meanwhile, when it is judged as coinciding (YES at S71), the processing at S33 shown in FIG. 7 is performed.

According to this third embodiment, the host first connection information 805R can be generated without having to interpose the host device 10. Thus, burden on the user operating the host device 10 can be eliminated.

Specifically, for instance, the CHA 2B diverts the host second port number contained in the IO-related information to the host first port number of the first memory control device 20 without change, diverts the host second LUN contained in the IO-related information to the host second LUN of the first memory control device without change, and generates the host first connection information 805R containing the host first port number (diverted host second port number), host first LUN (diverted host second LUN), and the number of the internal LDEV associated with the external LDEV 42. Thereupon, if a port number that is the same as the host second port number being used is detected from the shared memory 25 or the like, the CHA 2B will use an unused port number as the host first port number. Further, if a LUN that is same as the host second LUN being used is detected from the shared memory 25 or the like, the CHA 2B will use an unused LUN as the host first LUN.

In this third embodiment, (as with the first and second embodiments described above), in addition to WWN, a port number is prepared. Although a same WWN will not exist in the plurality of memory control devices 20, 40, it is possible that the same port number will exist in the plurality of memory control devices 20, 40. Unlike the WWN, the port number merely has to uniquely specify the port in the memory control device 20 or 40. As described above, by preparing a port number (does not have to be a number and may also be a symbol) separately from the WWN, including such port number in the IO-related information and diverting the port number contained in the IO-related information in the first memory control device 20, a logical path can be automatically defined in the first memory control device 20 between the host first port and the internal LDEV 32.

Incidentally, in this third embodiment, for example, the mapping table 803 can be generated with the following flow.

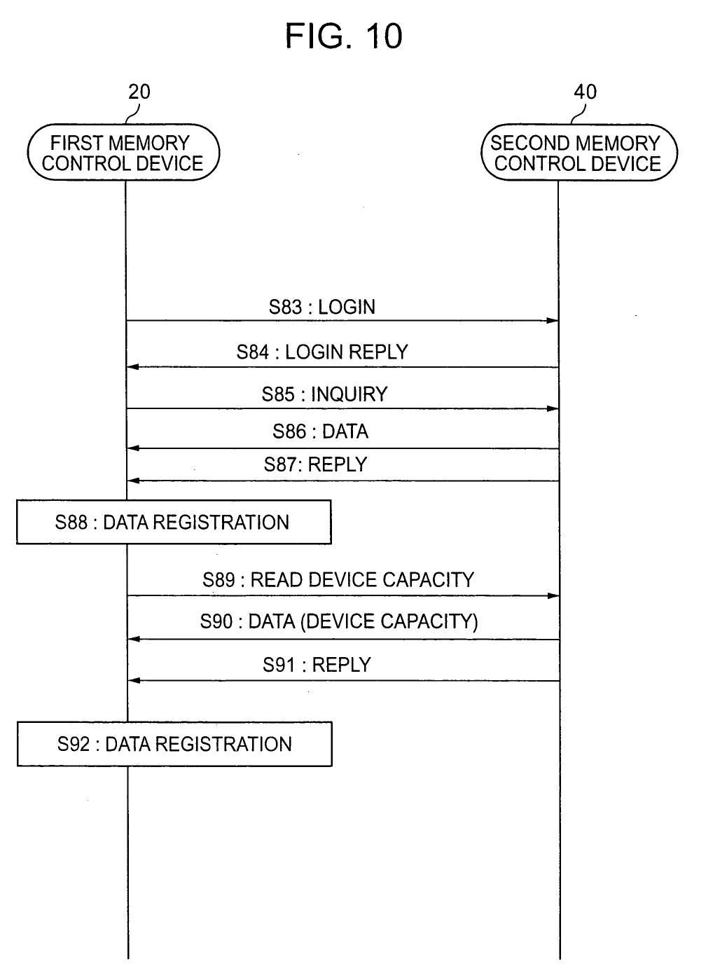

FIG. 10 is a diagram showing the flow of the processing for creating the mapping table 803 in the third embodiment of the present invention.

For example, the CHA 2B and a CHA (not shown) of the second memory control device 40 are connected via a fiber channel switch (not shown). Although not shown, for example, the CHA 2B issues a search command to the fiber channel switch, and, in response thereto, it receives from the fiber channel switch information required for logging in to the second memory control system 40 connected to the fiber channel switch (e.g., WWN of the communication port 41 connected to the fiber channel). And, the CHA 21B registers the login information for each second memory control system 40 received from the fiber channel switch in a local memory or shared memory 25.

The CHA 2B uses the registered login information and logs into the second memory control system 40 via the second first port 21B of the CHA 2B (S83). As a result of the second memory control system 40 responding to the login from the CHA 2B (S84), login will be complete.

Next, the CHA 2B, for example, transmits a referral command (inquiry command) set forth in a SCSI (Small Computer System Interface) standard to the second memory control system 40 (S85). The inquiry command referred to herein is used for clarifying the type or constitution of the device of the inquiree, and the inquirer of the inquiry command will be able to comprehend the physical constitution of the inquiree's device.

For example, the second memory control system 40 that received the inquiry command will acquire the control system information relating to the second memory control system 40 from the memory (not shown) within the second memory control system 40, transmit such control system information to the CHA 2B (S86), and return a prescribed response (S87). Incidentally, the control system information transmitted here, for example, is the vendor ID of the second memory control system 40, device name and product number, WWN of the communication port 41AA that received the inquiry command, LUN belonging to such WWN, LDEV number belong to such LUN, and the disk type provided in the LDEV.

The CHA 2B registers the received control system information (e.g., vendor ID of the second memory control system 40, system identifying information including the device name and product number, WWN and LUN, disk type) in a prescribed location of the mapping table 803 (S88).

Next, the CHA 2B transmits the inquiry regarding the memory capacity of the external LDEV 42 belonging to the LUN within the received control system information (e.g., read capacity command based on the SCSI protocol) to the second memory control system 40 (S89). The second memory control system 40 refers to the memory capacity information stored in the memory (not shown) within the second memory control system 40 (e.g., total memory capacity of one or more external LDEV 42 belong to the LUN) transmits to the CHA 2B the inquired memory capacity (i.e., the memory capacity of the external LDEV 42) (S90), and returns the response (S91). The CHA 2B registers the received memory capacity in a prescribed location of the mapping table 803 (S92).

The mapping table 803 can be created by performing the foregoing processing.

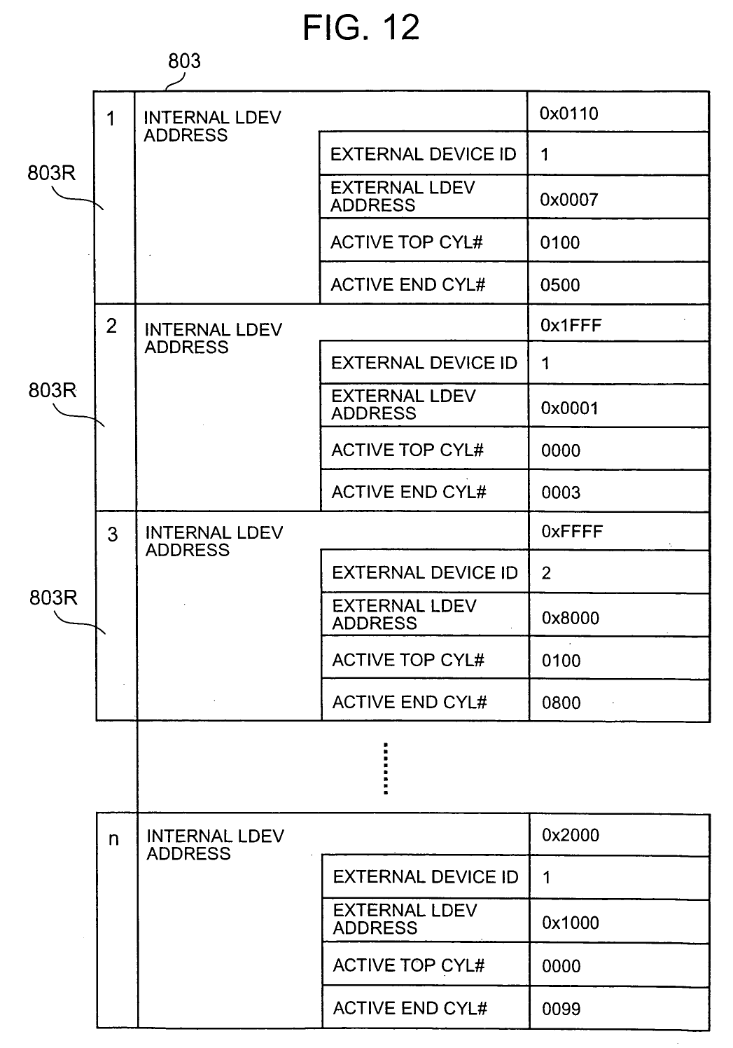

Although several preferred embodiments and examples of the present invention have been described above, these are merely exemplifications for explaining the present invention, and are not intended to limit the scope of the present invention to such embodiments. The present invention can be implemented in other various modes. For example, the present embodiments and examples are not limited an open system, and may also be employed in a mainframe system. The mapping table 803 to be employed in a mainframe system, for example, will be as described in FIG. 12.

What is claimed is:

1. A device,
wherein an external memory control device and a host device are connected to a control device;
said external memory control device has a plurality of external memory devices containing an external memory device to be accessed by said host device;
said control device has a plurality of memory devices, a first connection to be connected to said host device, and a second connection to be connected to said external memory control device;
said plurality of memory devices include a memory device associated with an external memory device;
said device comprising:
a first specifying unit for specifying a host access external memory device, which is an external memory device to be accessed by said host device, among the plurality of external memory devices;
a second specifying unit for specifying a mapping memory device, which is a memory device associated with said specified host access external memory device, among the plurality of memory devices; and
a logical path generation unit for generating a logical path between said specified mapping memory device and said first connection.

2. A device according to claim 1,
wherein said first specifying unit inputs host external information containing external device identifying information for identifying said host access external memory device, and acquires said external device identifying information from said host external information;
said second specifying unit acquires identifying information of said mapping memory device associated with said acquired external device identifying information from the mapping information in which identifying information of the memory device is associated with the identifying information of the external memory device; and
said logical path generation unit generates host first path information containing identifying information of said acquired mapping memory device, and connection identifying information of the first connection connected to said host device among one or more first connections.

3. A device according to claim 2,
wherein said connection identifying information is a number for specifying a first connection; and
said logical path generation unit acquires an unused number if the number scheduled to be contained in said host first path information has already been assigned to another first connection in said control device, and generates host first path information containing said acquired unused number.

4. A device according to claim 2,
wherein said host external information contains an external logical unit number associated with said host access external memory device;
said logical path generation unit determines whether the external logical unit number acquired from said host external information is usable in said control device, and, if usable, includes said external logical unit number in host first path information as the logical unit number associated with said mapping memory device, and, if unusable, acquires a usable logical unit number, and generates host first path information containing the acquired logical unit number.

5. A device according to claim 2,
wherein said external memory control device performs IO processing to the external memory device according to the IO request from said host device, generates IO monitor data, which is data relating to said IO processing, for each external memory device, and outputs IO-related information containing the identifying information of said external memory device and the IO monitor data;
said host external information is said IO-related information; and
said first specifying unit receives the IO-related information output from said external memory control device, and acquires identifying information of said external memory device from said IO-related information.

6. A device according to claim 2,
wherein said host external information is a text file described in a prescribed format.

7. A device according to claim 1,
wherein said first specifying unit, said second specifying unit and said logical path setting unit are mounted on at least one of said control device, said host device and said external memory control device in a concentrated or dispersed manner.

8. A method,
wherein an external memory control device and a host device are connected to a control device;
said external memory control device has a plurality of external memory devices containing an external memory device to be accessed by said host device;
said control device has a plurality of memory devices, a first connection to be connected to said host device, and a second connection to be connected to said external memory control device;
said plurality of memory devices include a memory device associated with an external memory device;
said method comprising:
a step of specifying a host access external memory device, which is an external memory device to be accessed by said host device, among the plurality of external memory devices;
a step of specifying a mapping memory device, which is a memory device associated with said specified host access external memory device, among the plurality of memory devices; and
a step of generating a logical path between said specified mapping memory device and said first connection.

9. A control device,
wherein an external memory control device and a host device are connected to a control device;
said external memory control device has a plurality of external memory devices containing an external memory device to be accessed by said host device;
said control device has a plurality of memory devices, a first port to be connected to said host device, and a second port to be connected to said external memory control device;
said plurality of memory devices include a mapping memory device associated with an external memory device;
said control device comprising:
a memory area for storing one or more computer programs; and
a processor operated by reading at least one among the one or more computer programs from said memory area;
said processor inputs host external information containing external device identifying information for identifying the host access external memory device to be accessed by said host device, and acquires said external device identifying information from said host external information;
acquires identifying information of said mapping memory device associated with said acquired external device identifying information from the mapping information in which the identifying information of the memory device is associated with the identifying information of the external memory device; and
generates host first path information containing said acquired identifying information of said mapping memory device, and the number of the first connection connected to said host device among the one or more first connections.
